(19) United States
(12) Patent Application Publication
(10) Pub. No.: US 2014/0272399 A1
(43) Pub. Date: Sep. 18, 2014

(54) COATED GRAIN ORIENTED STEEL

(71) Applicant: TATA STEEL UK LIMITED, London (GB)

(72) Inventors: Sivasambu Böhm, Rotherham (GB); Henagama Liyanage Mallika Böhm, Rotherham (GB); Sreedhara Sarma, Rotherham (GB)

(73) Assignee: TATA STEEL UK LIMITED, London (GB)

(21) Appl. No.: 14/355,610

(22) PCT Filed: Nov. 2, 2012
(86) PCT No.: PCT/EP2012/004569

§ 371 Date: May 1, 2014

(30) Foreign Application Priority Data
Nov. 4, 2011 (EP) 11008805.1

(51) Int. Cl. H01F 1/147

(52) U.S. Cl. CPC H01F 1/14783
USPC 428/336; 427/104; 428/447

(57) ABSTRACT

A method of producing a coated grain oriented steel strip, which includes the steps of: forming an insulating layer on the grain oriented steel strip; providing a chromium-free coating mixture that comprises a metal phosphate silica particles and an organosilane; applying the mixture on the insulating layer; and curing the mixture to form a chromium-free coating that provides tension to the grain oriented steel strip.

### FIELD OF THE INVENTION

The present invention relates to a method of providing a coated grain oriented steel strip, the coated grain oriented steel thus produced and to the use of the coated grain oriented steel strip in an electrical transformer.

### BACKGROUND

Grain Oriented (GO) electrical steels are an essential material in the manufacture of energy-efficient transformers with the performance of such transformers depending heavily on the magnetic properties of the GO steels that are used.

Magnetic properties may be improved by placing GO steels under tension. This is achieved by forming an iron silicon oxide (Fayerlite) layer on the surface of the steel strip by decarburisation annealing. Magnesium oxide powder is then applied in the form of slurry and the coils are heated to approximately 1200° C. in dry hydrogen. The magnesium oxide reacts with the iron silicon oxides to form a dull grey crystalline magnesium silicate (Forsterite) coating, which is known as a ‘glass film’. After the high temperature batch anneal, the coils are thermally flattened by annealing in a continuous furnace with a very low extension. During this process a phosphate based coating is applied to the steel to supplement insulation and further improve the tension of the steel.

Phosphate based coatings comprising silica and chromium compounds are commonly used to provide tension to the GO steel both during annealing and when the coated steel is implemented in high voltage electrical transformers. The use of hexavalent chrome also improves the corrosion resistance of the phosphate based coating, which is important when transporting and handling such coated GO steels, particularly in humid environments. Nevertheless, chromium compounds are known to be highly toxic and pose significant risks when handling and storing such compounds.

It is an object of the invention to provide a phosphate based coating for an electrical steel, preferably a grain oriented steel, which does not contain chromium compounds.

Another object of the invention is to provide a phosphate based coating that is free of chromium compounds, which when applied on a grain oriented steel, affords the same if not better coating performance in respect of tension and magnetic properties as those phosphate based coatings in which chromium compounds are present.

### SUMMARY OF THE INVENTION

According to a first aspect of the invention there is provided a method of producing a coated grain oriented steel substrate, which comprises the steps of:
i. forming an insulating layer on the grain oriented steel substrate;
ii. providing a chromium-free coating mixture that comprises a metal phosphate, silica particles and an organosilane;
iii. applying the mixture on the insulating layer;
iv. curing the mixture to form a chromium-free coating which provides tension to the grain oriented steel strip.

Advantageously, the chromium-free coating mixture does not contain chromium compounds and therefore the risks associated with the handling and storing of such compounds are avoided. Moreover, the amount of tension provided to the GO steel substrate increases significantly when the chromium-free coating mixture is used in preference to other coatings that contain chromium compounds. As a consequence the magnetic properties of GO steels coated with fosterite and the chromium-free coating are also significantly improved.

The metal phosphate increases the thermal stability of the chromium-free coating to an extent that the chromium-free coating is thermally stable up to a temperature of at least 800° C. The metal phosphate also contributes to improving the barrier properties of the chromium free coating such that the coating does not degrade during transport and/or handling. The presence of the organosilane in the chromium-free coating mixture improves the adhesion of the chromium-free coating to the underlying fosterite substrate and acts as barrier to prevent or at least reduce water ingress. The inventors attribute the improvement in magnetic properties to the combination of the organosilane, metal phosphate and silica particles in the chromium-free coating mixture. In addition to increasing the density of the chromium-free coating the organosilane also acts as a support to the silica particles, which results in an increase in the packing of the pores in the otherwise amorphous metal phosphate network. By increasing the packing density and the overall density of the chromium-free coating, the amount of tension afforded to the GO steel substrate is increased.

In a preferred embodiment of the invention the chromium-free coating mixture comprises organosilane functionalised silica particles. The organosilane and the silica particles may be dispersed within the metal phosphate network as independent components and/or the silica particles may be functionalised with the organosilane. When the chromium-free coating mixture contains the organosilane and silica particles as independent components the organosilane and silica particles become dispersed in the amorphous metal phosphate network. This leads to increased packing of the pores in the metal phosphate network and an overall increase in the density of the chromium-free coating. However, further improvements are obtained when organosilane functionalised silica particles are incorporated into the chromium-free coating mixture, which once cured, form an organosilane-silica network within the amorphous phosphate network. Because the silica particles are functionalised with the organosilane the organosilane effectively locks the silica particles in place and further improvements in packing density, tension and therefore magnetic properties are obtained.

In a preferred embodiment of the invention the organosilane comprises an alkoxysilane, preferably an ethoxy and/or methoxy silane. γ-glycidoxypropyltrimethyoxysilane, phenyltriethoxysilane, propyltrimethoxysilane or mixtures thereof are particularly preferred. These organosilanes comprise reactive functional groups that react with functional groups on the silica particle surface to produce functionalised silica particles. The use of γ-glycidoxypropyltrimethyoxysilane comprising epoxy groups to functionalise silica particles is particularly preferred. The above alkoxysilanes are also easily hydrolysed in the presence of water, allowing them to be used as precursors in sol-gel processing. The above organosilanes are stable in acidic solutions, i.e. solutions having a pH below pH 7, meaning that the detrimental effects of gelling on solution processing can be avoided or at least reduced to an extent that processing remains possible. Nevertheless, the presence of the alkoxy group permits the silane to be used in an unhydrolysed form if desired.

In a preferred embodiment of the invention the chromium-free coating mixture comprises silica nanoparticles and silica microparticles. This combination of silica particles, which may or may not be functionalised with an organosilane, provides superior packing of the pores in the dense network structure which improves the tension of the coating and thus the magnetic properties of the coated GO steel substrate. However, it should be understood that improved coating tension and magnetic properties are still possible when silica nanoparticles and silica microparticles are used independently due to the presence of functionalised and/or cross-linked organosilanes that support the silica particles in the dense network of the chromium-free coating.

In a preferred embodiment of the invention the silica nanoparticles have a particle diameter of 5-50 nm and/or the silica microparticles have a particle diameter of 1-50 μm. The inventors found that the amount of tension provided to the GO steel substrate could be increased by providing a chromium-free coating mixture comprising particles having the above particle diameters. However, chromium-free coating mixtures comprising nanoparticles and microparticles having a particle diameter of 10-40 nm and 1-10 μm respectively are particularly preferred.

In a preferred embodiment of the invention the ratio of silica nanoparticles to silica microparticles is at least 2:1 and preferably between 2:1 and 3:1. Advantageously, improved packing densities can be obtained when the content of silica nanoparticles in the coating mixture is greater than the content of silica micro particles. A ratio between 2:1 and 3:1 has proved particularly effective at increasing the amount of tension that is provided to coated GO steel substrate.

In a preferred embodiment of the invention the metal phosphate comprises aluminium phosphate, magnesium phosphate, zinc phosphate or a mixture thereof. As metal phosphate aluminium phosphate is preferred since the formation of a complex oxide between Al, Mg (from fosterite) and silica improves the humidity resistance of the coating. When using the aluminium and/or magnesium phosphate the coating mixture preferably contains chromium-free corrosion inhibitors to supplement the corrosion and humidity resistance of the coating. When the coating mixture comprises a mixture of metal phosphates, for instance a mixture of aluminium and magnesium phosphates, it is preferred that the aluminium phosphate content is greater than the content of magnesium phosphate. A preferred ratio of aluminium phosphate to magnesium phosphate is between >1:1 and 4:1, preferably >1:1 and 2:1.

In a preferred embodiment of the invention the chromium-free coating mixture comprises 15-40 wt % metal phosphate, 20-60 wt % silica particles and 5-15 wt % organosilane, preferably 25-35% metal phosphate, 25-50 wt % silica particles and 5-15 wt % organosilane. This range of components provides a robust dense network of the coating that increases the amount of tension provided to the grain oriented steel strip.

Preferably the chromium-free coating mixture comprises 15-40 wt % metal phosphate. A metal phosphate content above 40% results in a cured coating having reduced coating integrity which causes the coating to degrade when handled and/or during transport. A metal phosphate content below 15 wt % results in a coating which is porous and which does not provide enough tension to the steel strip. Coating mixtures comprising 25-35% metal phosphate are preferred since a good balance between coating integrity and tension is obtained.

Preferably the chromium-free coating mixture comprises 20-60 wt % silica particles. A silica content above 60 wt % can result in viscous coating mixtures that are difficult to process, whereas a silica content below 20 wt % reduces packing density which limits the amount of coating tension that can be provided to the steel strip. Preferably the silica particles comprise a mixture of silica nanoparticles and silica micro particles having a particle size of 10-40 nm, preferably 10-20 nm and 1-10 μm, preferably 1-2 μm respectively.

Preferably the chromium-free coating mixture comprises 5-15 wt % organosilane. Coatings produced from chromium-free coating mixtures comprising less than 5 wt % organosilane exhibit a reduction in barrier protection and packing density properties, whereas organosilane contents above 15 wt % reduce the thermal stability of the coating. For the avoidance of doubt the range of 5-15 wt % organosilane refers to the total amount of organosilane in the coating mixture, irrespective of whether the organosilane is used as a binder or to functionalise silica particles.

In a preferred embodiment of the invention the chromium-free coating mixture additionally comprises one or more of the following compounds:
chromium-free corrosion inhibitors;
silicate;
water

The chromium-free corrosion inhibitors preferably comprise inorganic compounds of V, Mo, Mn, Tc, Zr, Ce or mixtures thereof. Sodium metavanadate, zirconium silicate and/or cerium intercalated clay are particularly preferred. Conventional phosphate based coating mixtures comprise a high content of corrosion inhibitors in the form of chromium compounds, making such coating mixtures difficult to process and less environmentally acceptable. Due to the improved barrier and corrosion resistance properties associated with the chromium-free coating, acceptable corrosion resistance can be obtained even when the chromium-free coating mixture comprises ≦5 wt % corrosion inhibitors. A corrosion inhibitor content as low as 0.01 also improves the corrosion and humidity resistance of the chromium-free coating and therefore a corrosion inhibitor content of 0.01-1 wt % is preferred. Advantageously, the corrosion inhibitor content in the chromium-free coating mixture is lower than most conventional chromate based systems and therefore improvements in the processability of the chromium-free coating mixture relative to those conventional chromate based systems are obtained.

The chromium-free coating mixture may also comprise soluble silicates. By providing soluble silicates in the chromium-free coating mixture, a silicate and a silicate-phosphate network is formed when the chromium-free coating mixture is cured. The presence of the silicate and silicate-phosphate networks in the chromium-free coating increases the density, durability and toughness of the chromium-free coating thereby affording greater tension to the coated GO steel substrate as well as increasing the lifetime of the transformer. Preferably the chromium-free coating mixture comprises <5 wt %, preferably 0.1 to 2 wt % soluble silicate.

In a preferred embodiment of the invention the coating mixture is aqueous and therefore issues surrounding the storing, handling and disposal of non aqueous solvents are avoided.

In a preferred embodiment of the invention the chromium-free coating mixture is applied on the insulating layer in a continuous coating line having a coating line speed of at least 100 m/min. Conventional phosphate based coating mixtures can be viscous due to the size (nm) and concentration of corrosion inhibitors in the coating mixture. As a consequence these coating mixtures are typically applied on fosterite coated GO steels in coating lines having a coating line speed of 60-90 m/min. Since the chromium-free coating exhibits superior barrier properties and corrosion resistance the need to provide high concentrations of corrosion inhibitors is avoided or at least reduced. The chromium-free coating mixture possesses a viscosity in the range of 5-500 MPas which enables the chromium-free coating mixture to be applied in coating line having a coating line speed of at least 100 m/min and up to 180 m/min, preferably the coating line speed is between 140 and 180 m/min. Once applied the chromium-free coating mixture is cured at a temperature of at least 180° C. and preferably between 180° C. and 220° C. The method of the invention therefore offers a significant advantage in terms of processability.

According to a second aspect of the invention the coated grain oriented steel produced according to the first aspect of the invention comprises a chromium-free coating having a dry film thickness of 4-10 μm, preferably 4-6 μm. Chromium-free coatings having a dry film thickness above 10 μm tend to be brittle and are therefore less desirable from a handling and transporting perspective. On the other hand if the coating is too thin, i.e. below 4 μm then the tension provided to the GO steel substrate is not sufficient enough to improve the magnetic properties of the coated GO steel substrate.

In a preferred embodiment of the invention the coated grain oriented steel is thermally stable up to 850° C. at atmospheric pressure allowing the coating to withstand processing conditions employed during the thermal flattening of the coated strip in a continuous annealing furnace.

In a preferred embodiment of the invention the coated grain oriented steel has a percentage loss reduction of at least 2.5%, preferably between 4 and 15%. When a rapidly changing magnetic field is applied to a transformer the magnetic field causes grains in the GO steel to rotate. As the grains rotate and the boundaries between them shift, the GO steel increases and shortens in length, which results in noise (a low frequency hum) that is characteristic of all transformers. This effect is known as magnetostriction. It is thought that tension is directly related to magnetostriction and that the application of phosphate-based coatings increases tension, reduces magnetostriction and ultimately reduces noise.

Percentage loss reduction expresses the amount of energy that is lost when power is applied and transferred through a transformer. Much of the energy is lost through heat and noise from magnetostriction but other factors that contribute to the losses include transformer thickness, the steel chemistry of the strips or plates used to make the transformer, the size of the grains in the steel strip or plate and the presence of inclusions. Percentage loss reduction has been calculated by measuring the watts lost per kilogram when power is applied and transferred through a fosterite coated GO steel with and without a phosphate-based coating provided thereon, so that the influence of the phosphate-based coating in respect of total energy lost can be determined.

Equation (1) below is used to calculate the % loss reduction where “fosterite loss” corresponds to the amount of energy (W/Kg) lost when power is applied and transferred through a fosterite coated GO steel substrate and “coated loss” corresponds to the amount of energy (W/Kg) that is lost when power is applied and transferred through a GO steel substrate provided with a fosterite coating and a phosphate-based coating.

$$\frac{( Fosterite loss ) - ( Coated loss )}{( Fosterite loss )} \times 100 = \% loss Reduction \qquad ( 1 )$$

According to a third aspect of the invention the grain oriented steel strip according to the second aspect of the invention is used in an electrical transformer.

According to a fourth aspect of the invention there is provided a coated grain oriented steel comprising:
an insulating layer on the grain oriented steel strip
a chromium-free coating on the insulating layer, said coating comprising a metal phosphate, silica particles and an organosilane.

The preferences explained above with respect to the second aspect of the invention are similarly applicable to the coated grain oriented steel of fourth aspect of the invention.

According to a fifth aspect of the invention an electrical transformer comprises the coated grain oriented steel. Advantageously, energy efficient transformers are obtained when said transformers comprise the coated grain oriented steel of the invention.

### EXAMPLES

The invention will now be elucidated by way of example:

### Example 1

### Preparation of Functionalised Silica

A mixing vessel was charged with γ-glycidoxypropyltrimethyoxysilane in water and stirred for 1-2 hours to produce the corresponding hydrolysed silane comprising reactive Si—OH groups. To this solution silica particles having a particle size of 30 nm were added and this mixture was mechanically stirred for a period of 24 hours. During this period Si—OH groups of the hydrolysed silane react with OH groups on the silica particle surface to form a stable Si—O—Si bond. After 24 hours a clear homogenous solution comprising the functionalised silica is obtained.

### Example 2

### Preparation of a Coating Mixture

The Coating mixture compositions (weight %) of coating mixtures 1-4 are shown in Table 1. The methods of preparation for each of the coating mixtures are given below.

Coating Mixture (C1)

A mixing vessel was charged with aluminium phosphate (51% w/w, 560 g), micro-sized silica particles (18% w/w, 400 g) and water (128 g) and subsequently stirred for a period of 1-2 hours.

Coating Mixture (1)

Aluminium phosphate (51% w/w) in water (532 g) is provided in the mixing vessel containing the homogeneous solution of functionalised silica particles (29% w/w) in water (940 g). Sodium metavanadate (1 g) and phosphoric acid (1 g) are subsequently added to the mixing vessel and this mixture is stirred for a period of 1-2 hours.

Coating Mixture (2)

Aluminium phosphate (51% w/w, 408 g) and magnesium phosphate (51% w/w, 180 g) both in water were provided in the mixing vessel containing the homogeneous solution of functionalised silica particles (30% w/w, 1250 g). Micro-sized silica particles (60 g), sodium metavanadate (60 g), phosphoric acid (60 g) and water (64 g) were subsequently added to the mixing vessel and this mixture is stirred for a period of 1-2 hours.

Coating Mixture (3)

Aluminium phosphate (51% w/w, 400 g) in water was added to the mixing vessel containing the homogeneous solution of functionalised silica particles (29% w/w, 705 g). To this solution γ-glycidoxypropyltrimethyoxysilane (30% w/w, 300 g) and water (95 g) were subsequently added and this solution was stirred for a period of 1-2 hours.

Coating Mixture (4)

Aluminium phosphate (51% w/w, 400 g) in water was added to the mixing vessel containing the homogeneous solution of functionalised silica particles (29% w/w), 750 g). Soluble sodium silicate (40% w/w, 10 g), phosphoric acid (10 g) and water (95 g) were subsequently added to the mixing vessel and this mixture was stirred for a period of 1-2 hours.

TABLE 1
Coating mixture composition of coating
mixtures 1-4 and comparative example C1

| | Coating mixture | | | | |
|---|---|---|---|---|---|
| Composition (wt %) | C1 | 1 | 2 | 3 | 4 |
| Metal phosphate | 26 | 29 | 25 | 26 | 29 |
| Organosilane | — | — | — | 11 | — |
| Functionalised silica (nm) | — | 29 | 32 | 26 | 29 |
| Silica (μm) | 7 | — | 1 | — | — |
| Corrosion inhibitor | — | 0.1 | 5 | — | — |
| Silicate | — | — | 4 | — | 2 |
| Water | 67 | 41.9 | 33 | 37 | 40 |

### Example 3

### Coating Mixture Application

The viscosity of the coating mixture is adjusted to within the range of 5-500 mPa·s. The coating is then applied on a fosterite coated GO strip by roll coating in a continuous coating line having a coating line speed of 140 m/min. When applying the coating mixture the difference in coating thickness across the width of the GO strip should be ±2 μm. The applied coating mixture is subsequently cured at a temperature between 180 and 220° C., with a residence time of 30-60 seconds. Curing techniques such as near infrared curing and induction curing may be used.

### Experiments

Experiments were performed to determine the magnetostriction and the percentage loss reduction associated with coated GO steel strips provided with coating mixtures 1-4 (Table 2). For comparative purposes GO steel strips provided with commercially available phosphate based coatings were also tested. The coating mixture of comparative example C1 comprises a metal phosphate and micro-sized silica particles, whereas the coating mixture of comparative example C2 contains a metal phosphate, silica particles and chromium compounds.

Magnetostriction stress sensitivity curves were measured before and after coating mixtures 1-4 and C1-C2 were provided on fosterite coated GO steel strips. By comparing the before and after stress sensitivity curves It was possible to measure the shift in stress sensitivity and indirectly determine the amount of tension being applied to the underlying GO steel strip surface. In general, a high magnetostriction value is indicative of improved tension.

TABLE 2
Assessment of % loss reduction and magnetostriction for GO strips
coated with coating mixtures 1-4 and comparative example C1.

| | Coating mixtures | | | | |
|---|---|---|---|---|---|
| | C1 | 1 | 2 | 3 | 4 |
| Magnetostriction | 0 | 3.6 | 2 | 2 | 2.8 |
| % loss reduction | 0 | 10.1 | 6.0 | 7.2 | 5.1 |

Table 2 shows the magnetostriction and % loss reduction values for GO steel strips that were provided with coating mixtures of the invention (1-4) and comparative example C1. It is clear from Table 2 that fosterite coated GO steel strips provided with any one of coating mixtures 1-4 exhibit an improvement in % loss reduction relative to comparative examples C1. By coating GO steel strips with coating mixture (1), the % loss reduction (10.1%) increased by more than a factor of 2 relative to C2 (4.5%) and by more than a factor of 10 relative to C1 (0%).This increase is significant because a 1% improvement in % loss reduction results in a 3-4 tonne reduction in CO₂ per tonne of coated grain oriented steel used in a transformer, over the transformers lifetime (>25 years).

1. A method of producing a coated grain oriented steel strip, comprising the steps of:
i. forming an insulating layer on the grain oriented steel strip;
ii. providing a chromium-free coating mixture that comprises a metal phosphate, silica particles and an organosilane;
iii. applying the mixture on the insulating layer;
iv. curing the mixture to form a chromium-free coating that provides tension to the grain oriented steel strip.

2. A method of producing a coated grain oriented steel strip according to claim 1, wherein the chromium-free coating mixture comprises organosilane functionalised silica particles.

3. A method of producing a coated grain oriented steel strip according to claim 2, wherein the organosilane comprises γ-glycidoxypropyltrimethyoxysilane, phenyltriethoxysilane, propyltrimethoxysilane or a mixture thereof.

4. A method of producing a coated grain oriented steel strip according to claim 1, wherein the coating mixture comprises silica nanoparticles and silica microparticles.

5. A method of producing a coated grain oriented steel strip according to claim 4, wherein the silica nanoparticles have a particle diameter of 5-50 nm and/or the silica microparticles have a particle diameter of 1-50 μm.

6. A method of producing a coated grain oriented steel strip according to claim 4, wherein the ratio of silica nanoparticles to silica microparticles is at least 2:1.

7. A method of producing a coated grain oriented steel strip according to claim 1, wherein the metal phosphate comprises aluminium phosphate, magnesium phosphate, zinc phosphate or a mixture thereof.

8. A method of producing a coated grain oriented steel strip according to claim 1, wherein the coating mixture additionally comprises one or more of the following compounds:
chromium-free corrosion inhibitors;
silicate;
water.

9. A method of producing a coated grain oriented steel strip according to claim 8, wherein the chromium-free corrosion inhibitors comprise inorganic compounds of V, Mo, Mn, Tc, Zr, Ce or mixtures thereof.

10. A method of producing a coated grain oriented steel strip according to claim 1, wherein the coating mixture comprises 15-40 wt % metal phosphate, 20-60 wt % colloidal silica, and 5-15 wt % organosilane.

11. A method of producing a coated grain oriented steel strip according to claim 1, wherein the coating mixture is applied on the insulating layer at a moving strip speed of at least 100 m/min.

12. A coated grain oriented steel strip comprising:
an insulating layer on the grain oriented steel strip
a chromium-free coating on the insulating layer, said coating comprising a metal phosphate, silica particles and an organosilane.

13. A coated grain oriented steel according to claim 12, wherein the chromium-free coating has a dry film thickness of 4-10 μm.

14. A coated grain oriented steel according to claim 12, wherein the chromium-free coating is thermally stable up to 850° C. at atmospheric pressure.

15. A coated grain oriented steel according to claim 12, wherein the percentage loss reduction is at least 2.5%.

16. Use of the coated grain oriented steel strip according to claim 12 in an electrical transformer.

17. Electrical transformer comprising the coated grain oriented steel strip according to claim 12.

18. Coated grain oriented steel according to claim 12, wherein the chromium-free coating has a dry film thickness of 4-6 μm.
